(19) United States
(12) Patent Application Publication
(10) Pub. No.: US 2018/0227473 A1
(43) Pub. Date: Aug. 9, 2018

(54) SMART HOME SECURITY CONTROL DEVICE

(71) Applicant: Kaipo Chen, Taoyuan City (TW)

(72) Inventor: Kaipo Chen, Taoyuan City (TW)

(21) Appl. No.: 15/943,734

(22) Filed: Apr. 3, 2018

Related U.S. Application Data
(63) Continuation-in-part of application No. 14/472,403, filed on Aug. 29, 2014.

(30) Foreign Application Priority Data
Jun. 24, 2014 (CN) 201410289447.5

(51) Int. Cl. H04N 5/225; G06K 9/00

(52) U.S. Cl. CPC H04N 5/2256; G06K 9/00771; H04N 5/2252

(57) ABSTRACT

An image-recognizing lighting device includes a lighting device including, arranged therein, a master control board, an infrared sensor, and an LED for lighting. The master control board is connected to an image module. The image module includes an image capturing unit that captures an image of a front side of a person within and covering an angular range of 180 degrees; an image storage unit that stores the image and pre-stored data of the person; and an image recognition unit that is connected to the image storage unit to access the image for analysis to acquire a characteristic value and controls, according to a result of comparing the characteristic value with the pre-stored data, activation/de-activation of lighting and video recording, and is connected to an expansion module of the master control board to provide sound reminder and data transmission to enhance flexibility of use in addition to accurate image recognition.

### CROSS-REFERENCE TO RELATED APPLICATION

This is a continuation-in-part of co-pending U.S. patent application Ser. No. 14/472,403 filed on Aug. 29, 2014.

### (a) TECHNICAL FIELD OF THE INVENTION

The present invention relates generally to capturing of an image at a specific angle for further driving, based on data acquired through recognition and analysis, a lighting device to conduct a related operation.

### (b) DESCRIPTION OF THE PRIOR ART

The progress of technology and science brings improvements of image-capturing surveillance device, in respect of the size thereof, such that outside appearances that feature developments for compactness and miniaturization are now available. For an actual application of image capturing in a concealed condition, external knobs must be provided and externally connected, or a wireless controller must be included to operation with manual control. Deficiency of being inconvenient exists for applications in hidden image capturing for surveillance of a specific site or for use for an extended period of time.

For example, US Patent Application Publication No. US 2008/0177646 A1 propose a system and a method that record employees' behavior in a remote work site and information so obtained is stored for performances of various operations through the Internet.

The disclosure of the above-mentioned patent provides details, where an overall architecture is described as being such that fingerprints are first scan electronically and data related thereto are transmitted through the Internet to a database of a server for recognition of the identity of an employee. A camera is then driven as an assistive measure for tracking movement of an object. For applications concerning recognition, the fingerprint scanning is provided simply for determining if an employee is entering the work site. Although the patent mentions recognition can be done without being limited to fingerprint, retina, iris, face, and palm, yet there is no mentioning concerning application of recognizing the identity of an employee directly without being in on-line connection with a server.

There are manufacturers in the field of image-capturing surveillance field, proposing applications to lighting device, such that once powered, lighting and capturing and storing images can be conducted. This often results in insufficiency of storage or poor image quality so stored due to operation of extended period of time. Such deficiencies indicate that there is still room for further improvement.

### SUMMARY OF THE INVENTION

The present inventor provides an image-recognizing lighting device, which comprises: a lighting device, which comprises, arranged in an interior space thereof, a master control board, an infrared sensor, an LED for lighting, and an image module. The image module is connected to the master control board and the image module further comprises: an image capturing unit, an image storage unit, and an image recognition unit to capture, by means of the image capturing unit, at least one image of a front side of a person or a human being within and covering an angular range of 180 degrees and to access pre-stored data of the person for analysis of the image conducted with the image recognition unit to acquire a characteristic value, such that when the characteristic value matches the pre-stored data, the master control board is caused to activate the LED for lighting and when the characteristic value does not match the pre-stored data, in addition to activation of the LED for lighting, the image capturing unit is also activated for the purposes of video recording and storage.

Hardware/software functions of the prior art are shown in the following Table 1:

TABLE 1
Hardware/software functions of Prior Art of US 2008/0177646 A1

| US2008/0177646 | |
|---|---|
| (Prior Art) | Hardware/Software Functions |
| fingerprint scanner | fingerprint scanning/user identification |
| IP camera | image capturing/remote control |
| PIR sensor | human body infrared/target detection |
| router | network/data transmission and control |
| computer | communication/user end control and integration |

Hardware/software functions of the present invention are shown in the following Table 2:

TABLE 2
Hardware/software functions of the present invention

| The Present Invention | Hardware/Software Functions |
|---|---|
| image capturing unit (21) | image capturing/picture or video format |
| image storage unit (22) | image storage/accessible for image recognition |
| image recognition unit | image recognition/user identification |
| (23) | |
| infrared sensor (12) | human body infrared/target detection |
| transmission unit (32) | image and information transmission/operation |
| | by master control board |
| master control board (11) | hardware integration/for control and use |
| LED (13) | lighting/activation by master control board |
| rotatable seat (14) | adjustable installation/installation in various |
| | environments |
| sound effect unit (31) | reminder and alarm/operation by master |
| | control board |

Hardware differences between Prior Art and the present invention are listed below in Table 3:

TABLE 3
hardware differences between Prior Art and the present invention

| US 2008/0177646 | Present Invention |
|---|---|
| fingerprint scanner | NA |
| IP camera | image capturing unit (21) |
| | image storage unit (22) |
| | image recognition unit (23) |
| PIR sensor | infrared sensor (12) |
| router | transmission unit (32) |
| computer | master control board (11) |
| NA | LED (13) |
| NA | rotatable seat (14) |
| NA | sound effect unit (31) |

Table 4 provides a brief discussion regarding the hardware differences between Prior Art and the present invention.

TABLE 4
Comparison of difference between Prior Art and this invention
Differences between Prior Art (US 2008/0177646) and
the present invention

| hardware of US 2008/0177646 | hardware of the present invention |
|---|---|
| fingerprint scanner | NA |

| | |
|---|---|
| hardware | Fingerprint scanner is used to determine if the user is the |
| difference | person himself or herself; the present invention does not |
| | need to identify a user by means of fingerprint scanning. |

| | |
|---|---|
| IP camera | image capturing unit (21) |
| | image storage unit (22) |
| | image recognition unit (23) |

| | |
|---|---|
| hardware | IP camera features remote control of image taking angle for |
| difference | capturing a desired image; in the present invention, the |
| | image capturing unit (21) is a photographing device or a lens, |
| | the image storage unit (22) stores, in advance, pre-stored data |
| | of a user and also stores an image captured by the image |
| | capturing unit (21), of which IP remote control is achieved |
| | with the transmission unit (32) so as to fulfill in a |
| | different way, whereby a difference between the two is that |
| | the present invention provides an image recognition unit (23) |
| | that acquires an image of a front side of a user within an |
| | angular range of 180 degrees by means of he image capturing |
| | unit (21) and then recognition of such an image is conducted |
| | with the pre-stored images to determine if the user is person |
| | himself or herself and other functions of associated with the |
| | data, such that when the user is the person himself or herself, |
| | then video recording is omitted, while video recording is |
| | carried out if the user is not the person himself or herself, |
| | this making the image or video recording of this invention |
| | more flexible than Prior Art. |

| | |
|---|---|
| PIR sensor | infrared sensor (12) |

| | |
|---|---|
| hardware | Target is detected by means of human body infrared radiation |
| difference | in order to drive IP camera or image capturing unit (21), |
| | this being the same for both cases. |

| | |
|---|---|
| router | transmission unit (32) |

| | |
|---|---|
| hardware | Router provides data transmission and control for connection |
| difference | through a network for the computer (the user end) and the IP |
| | camera and the difference is that the transmission unit (32) of |
| | the present invention is operable, through various wireless |
| | techniques, to transmit captured and stored images or |
| | information obtained with recognition operation to the master |
| | control board or an externally connected device for subsequent |
| | uses and applications. |

| | |
|---|---|
| computer | master control board (11) |

| | |
|---|---|
| hardware | Computer is generally provided for communication control, |
| difference | user end control and integration of various information; |
| | the master control board (11) of the present invention is |
| | applicable in a lighting device to provide, in addition to the |
| | functions that a regular computer may achieve, direct |
| | hardware integration and to directly conduct various |
| | applications and operations through the transmission unit (32) |
| | so that the size of the entire device can be minimized without |
| | additional connection with extra hardware devices. |

| | |
|---|---|
| NA | LED (13) |

| | |
|---|---|
| hardware | The present invention involves an application to a lighting |
| difference | device and the LED (13) provides a function of lighting or |
| | illumination in this invention and is generally controlled by |
| | the master control board for activation and de-activation. |

| | |
|---|---|
| NA | rotatable seat (14) |

| | |
|---|---|
| hardware | The rotatable seat (14) of this invention is provided for |
| difference | installation in various environments to allows the image |
| | capturing unit (21) to capture images in a widened range. |

| | |
|---|---|
| NA | sound effect unit (31) |

| | |
|---|---|
| hardware | The sound effect unit (31) of this invention functions to |
| difference | provide reminder and alarm and is driven and used by the |
| | master control board. |

The contents of Table 1 to Table 4 reveal that the prior art US patent document involves hardware that includes a router, an IP camera, a fingerprint scanner, PIR sensors, and a computer. When an employee that is under surveillance enters a work site, a fingerprint is input through the fingerprint scanner to generate identification data that is transmitted through the router and a network to the computer to confirm if it is the employee himself or herself. If the identity is confirmed, then the employee is allowed to enter the work site. Afterwards, an IP camera that is remotely controlled is operated to track and perform video recording to thereby achieve the purpose of management and control. The tracking and video recording are conducted with thermal detection and motion detection algorithm

On the other hand, this invention involves image-recognizing hardware that includes an image module that comprises an image capturing unit to capture an image of a person; an image storage unit that stores, in advance, pre-stored data of the person that is acquired with the image capturing unit; and an image recognition unit that carries out, afterwards, an operation of conversion of the image so captured into a characteristic value for comparison with the pre-stored data to determine if the person is a specific person and subsequent activation of an LED for lighting and also activation of video recording with the image capturing unit. All these operations performed with the present invention are conducted completely and directly within the lighting device, without any need for connection with an external computer for performance of such operations or for being assisted for performance of such operations. Thus, in consideration of the deficiencies of the prior art, the present invention is made to use function units included in an image module to carry out capturing, comparison, and storage of images and making use of the master control board to drive an expansion module associated therewith for achieving more efficient recognition and applications thereof.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a system block diagram of the present invention.

FIG. 2 is a flow chart illustrating a process of determining if it is a person according to the present invention.

FIG. 3 is a schematic view illustrating an application of the present invention.

FIG. 4 is a schematic view illustrating an application of the present invention.

FIG. 5 is a schematic view illustrating an application of the present invention.

FIG. 6 is a schematic view illustrating an application of the present invention.

FIG. 7 is a schematic view illustrating an application of the present invention.

FIG. 8 is a schematic view illustrating an application of FIG. 5 of the present invention.

FIG. 9 is a schematic view illustrating an application of the present invention.

FIG. 10 is a schematic view illustrating an application of FIG. 9 of the present invention.

FIG. 11 is a schematic view illustrating an application of the present invention.

FIG. 12 is a schematic view illustrating an application of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

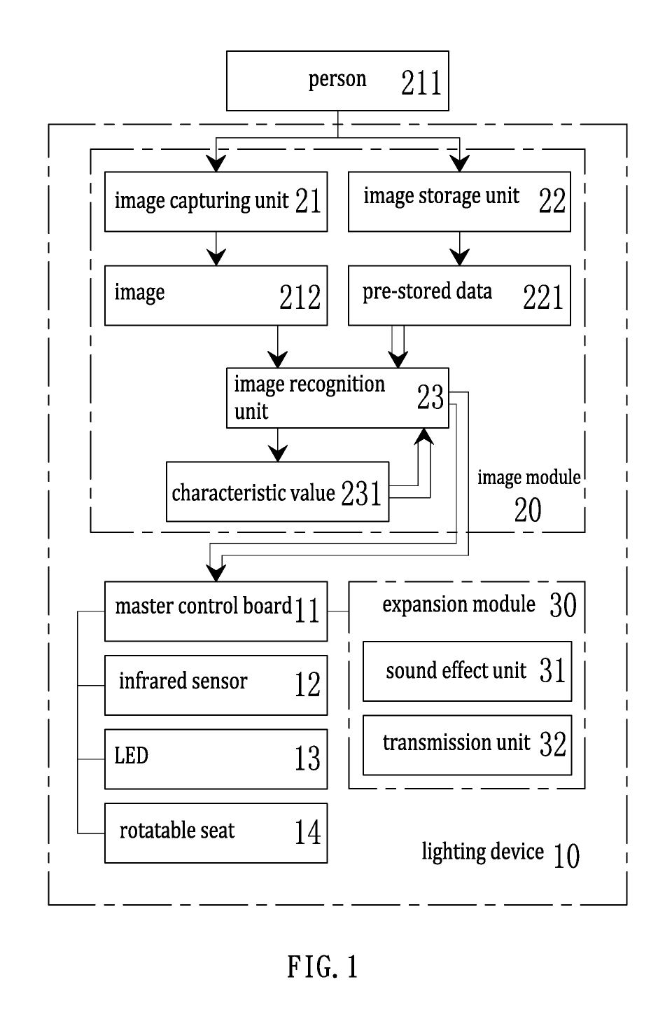

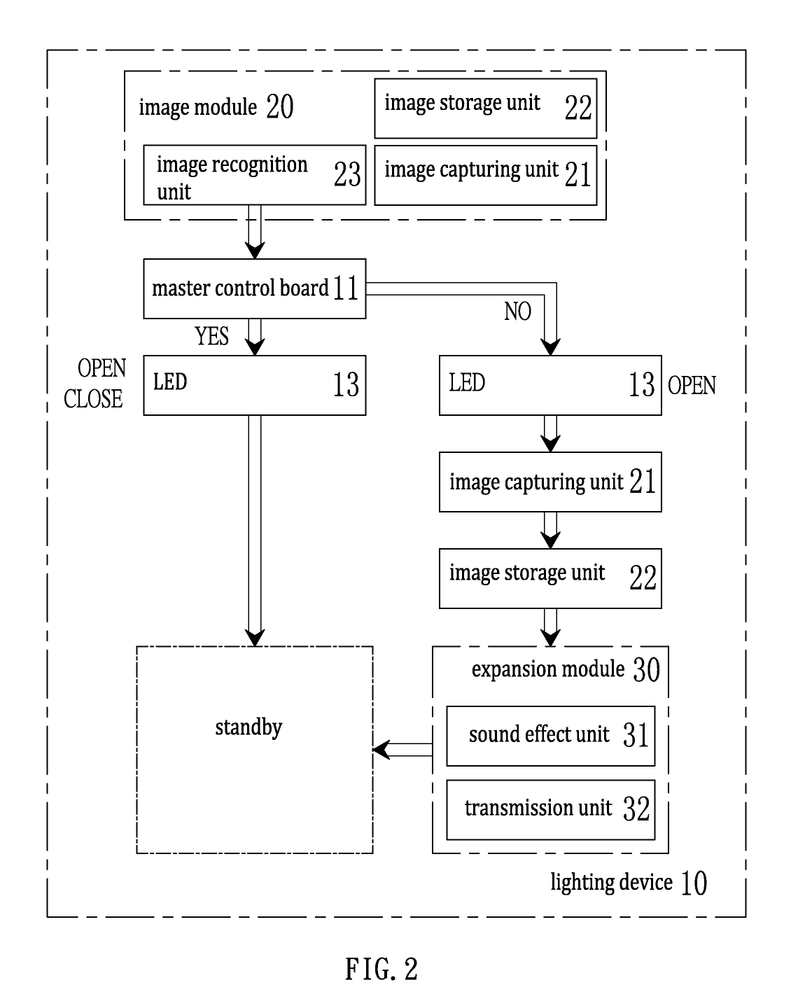

Referring to FIGS. 1-2, the present invention provides an image-recognizing lighting device, which comprises: a lighting device (10) that comprises, arranged and mounted in an interior space thereof, a master control board (11), an infrared sensor (12), a light-emitting diode (LED) (13), and an image module (20) connected to the lighting device (10). The master control board (11) comprises a processor that processes data and information.

The image module (20) comprises: an image capturing unit (21), which is generally a photographing device or a lens that captures or picks up at least one image (212) of a front side of a human being or a person (211) within an angular range of 180 degrees, wherein the front side is defined as one side of a human being containing a face, a body, and/or limbs; an image storage unit (22), which comprises read only memory or flash memory built in the master control board (11) and may be additionally arranged as an externally-expandable structure, no limitation being imposed herein, the image storage unit (22) being provided for storage of the previously-discussed image (212) and one or more items of pre-stored data (221) of the human being (211), the pre-stored data (221) being such that multiple pictures of the entire body of the human being (211) taken from the front side and various directions for extraction of facial components, limb lengths, body height, hair style, hair color, skin color, neck length, shoulder width, facial feature, bones, and the likes to be converted into related parameters, wherein the parameter conversion used in this invention can be any known technique currently available in the market and is not a novel part of this invention; an image recognition unit (23), which is connected to the image storage unit (22) to access the image (212), the image recognition unit (23) being operable to analyze the image (212) to acquire a characteristic value (231), the analysis being similar to the above-described conversion of the pre-stored data (221) into the parameter so that repeated description will be omitted, the image recognition unit (22) being operable to carry out matching of the characteristic value (231) with the pre-stored data (221).

When it is determined that the characteristic value (231) matches the pre-stored data (221), the master control board (11) activates the LED (13) to give off light for illumination; when the characteristic value (231) does not match the pre-stored data (221), the master control board (11) activate the LED (13) for illumination and also controls the image capturing unit (21) to carry out video recording and storage. When the human being or person (211) moves out of a detection range, video recording and lighting or illumination are shut down and entry into a standby condition is made to wait for re-activation at the time when a next person or human being (211) enters the detection range.

The lighting device (10) is additionally provided therein with an expansion module (30). The expansion module (30) is connected to the master control board (11) and the expansion module (30) further comprises: a sound effect unit (31), which is operable to provide reminder and alarm or warning; and a transmission unit (32), which is operable for transmission of the image and data or information, through WIFI, LIFT, Bluetooth, Z-WAVE, ZigBee, or other wireless communication technology, to or from an external device, such as a tablet computer, a smart phone, Internet of Vehicle, or handheld and/or wearable device, wherein the data or information so transmitted can be audio or digital data or information. For example, when the transmission unit (32) uses WIFI techniques, wireless connection thereof can be made with an external memory device, such as a hard disk drive, that supports wireless communication, so that video recording stored in the image storage unit (22) can be transmitted to the external hard disk drive or a cloud space in order to maintain a predetermined amount of free memory space in the storage unit (22).

According to different types of lighting device (10) involved, the master control board (11) may include additional stable supply of power, or an independent power supply measure, such as a power board (15), for the purposes of enhanced stability of power supply for the operation of the entire device, but this is not necessary. The infrared sensor (12) is operable for detecting if a human being or person (211) enters/leaves the detection range. When a human being or person (211) is detected, feedback information is transmitted to the master control board (11) to “wake up” the image module (20) that is in a standby condition, this being different from prior art where thermal detection is taken as a primary measure for activation of the functions of lighting/illumination and video recording/image capturing.

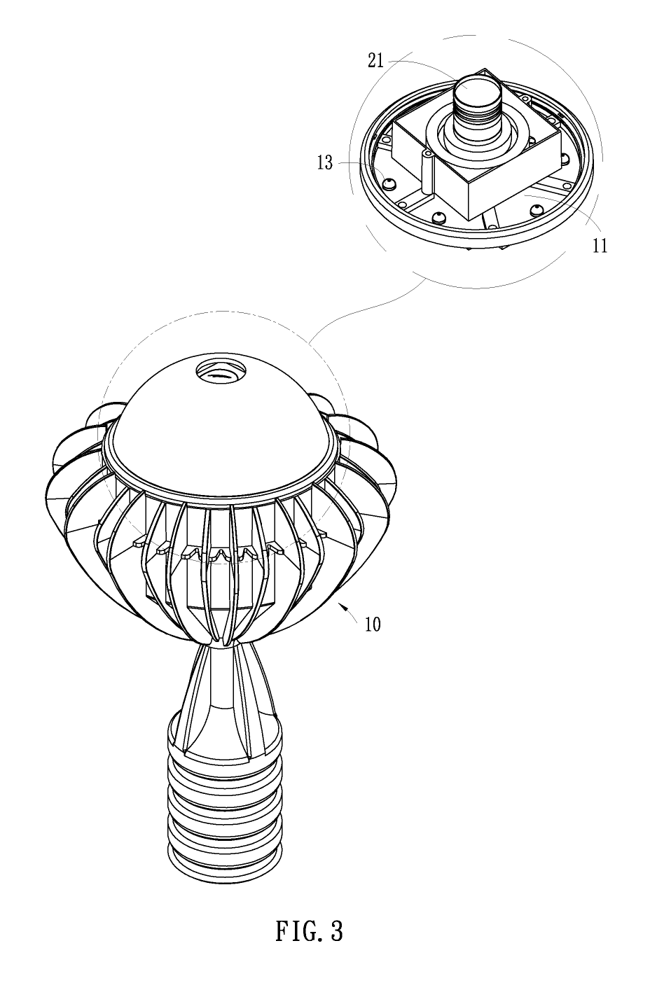

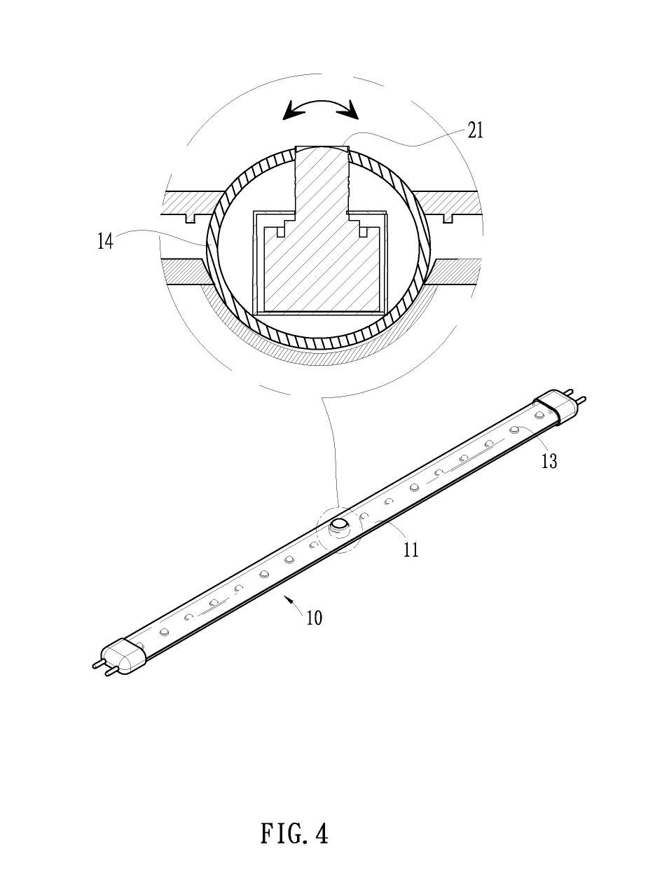

Referring to FIG. 3, the lighting device (10) can be optionally of a form of a light bulb that could be mounted through screwing into and being attached to a socket to receive a supply of power for operation. The functions of image recognition and activation of video recording and illumination as described previously can be carried out without addition or installation of other devices or components being involved. FIG. 4 shows an example of the lighting device (10), which is in the form of a fluorescent tube normally used in combination with a lighting tube holder for proper operation, yet the installation or mounting is relatively easy. A unique feature of this structure is that the lighting device (10) is arranged to set the image capturing unit (21) in a middle portion thereof with a rotatable seat (14) being arranged at a bottom thereof for adjustment of the image capturing unit (21) through rotation or twisting in order to vary the angular position for making video recording.

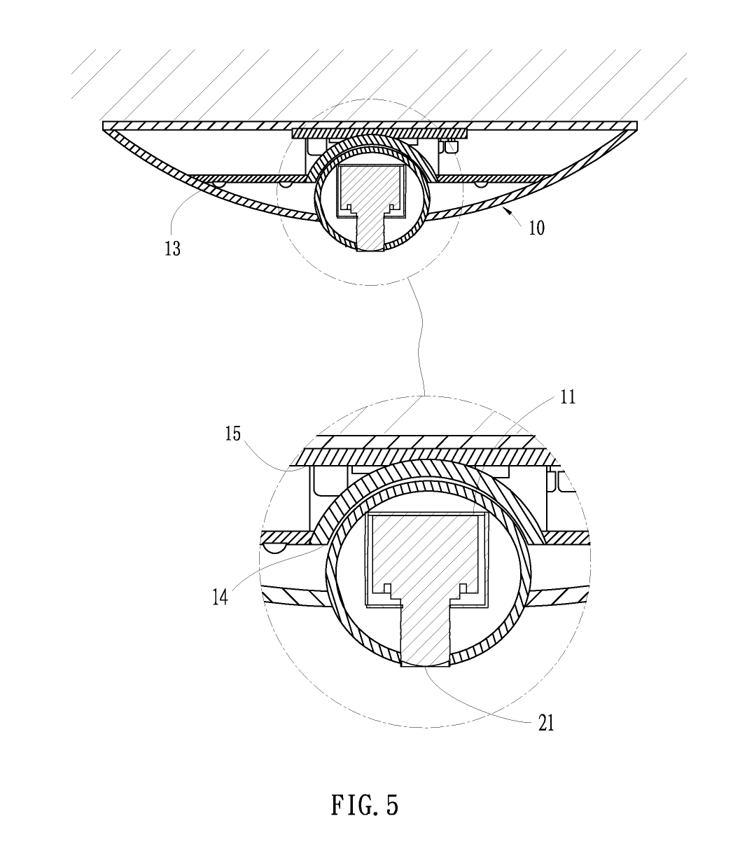

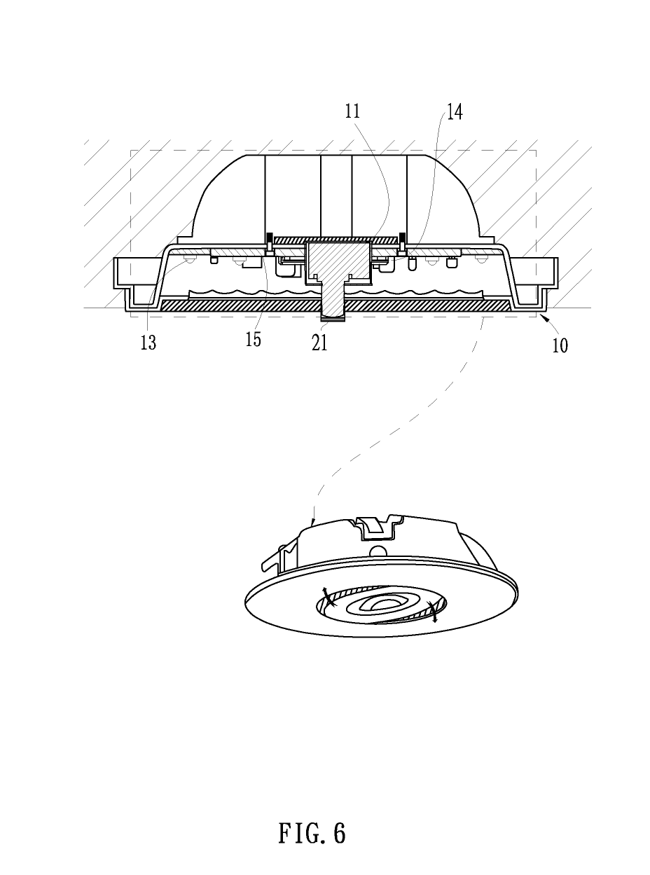

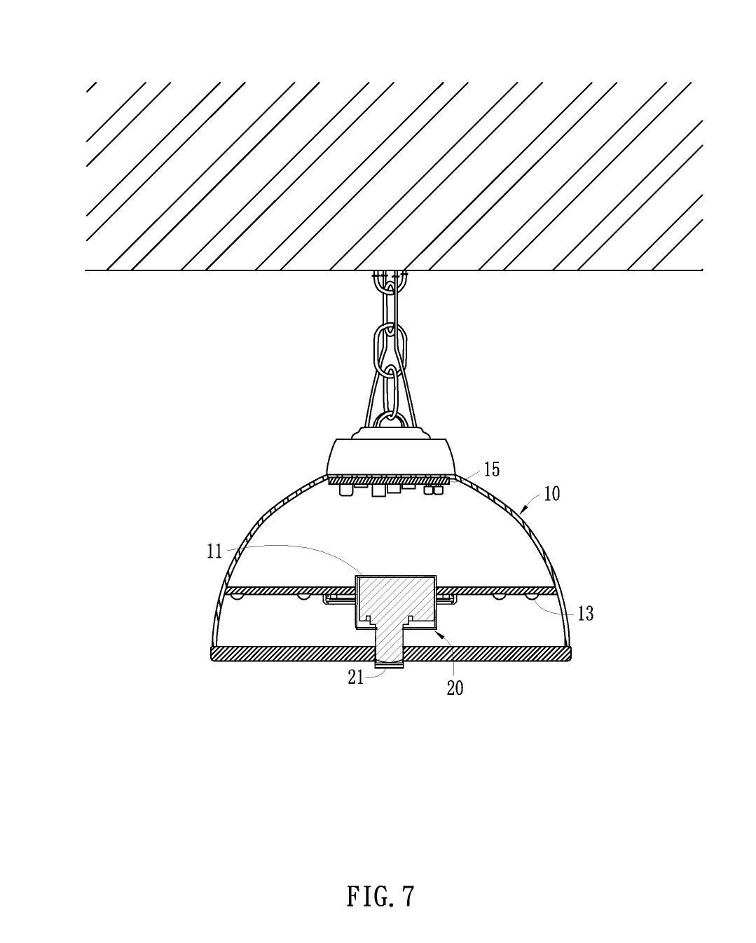

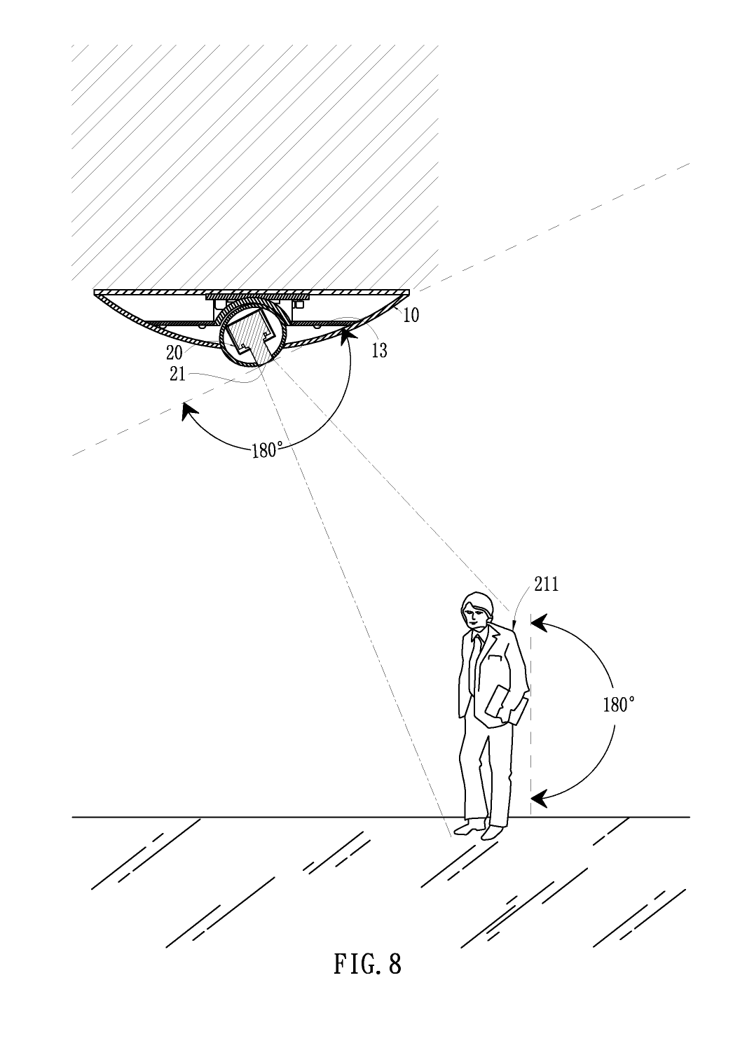

Referring to FIGS. 5-8, various examples of this invention are provided, wherein FIG. 5 shows a ceiling light; FIG. 6 shows a recessed light; and FIG. 7 shows a pendant light, these three lights being similar to one another, while FIG. 8 illustrates an application or use of the ceiling light of FIG. 5 for better demonstration of installation for carrying out recognition of an image (212) within an angular range of 180 degrees as mentioned previously, wherein the lighting device (10) is mounted to a high location adjacent to or close to a ceiling and wherein a phantom line is shown parallel to a front end face of a lens of the image capturing unit (21), the phantom line indicating 180 degrees of a vision range of the image capturing unit (21), whereby when a person located below the device and moves into a predetermined distance of the human being (211), the infrared sensor (12) wakes up the master control board (11) to carry out the process of recognizing the image (212). An angular range of 180 degrees is particularly marked by the person (211) to indicate that the vision range of the image capturing unit (21) could completely cover the person and could completely capture the front side of the human being (211). A matching operation that will be conducted thereafter on the image (212) has been clearly described previously so that repeated description will be omitted.

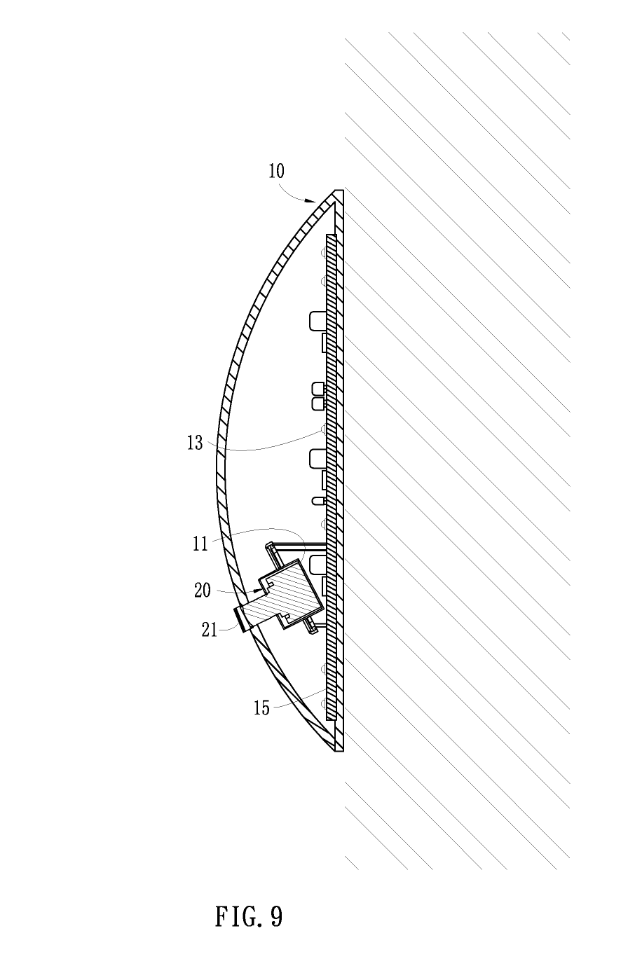

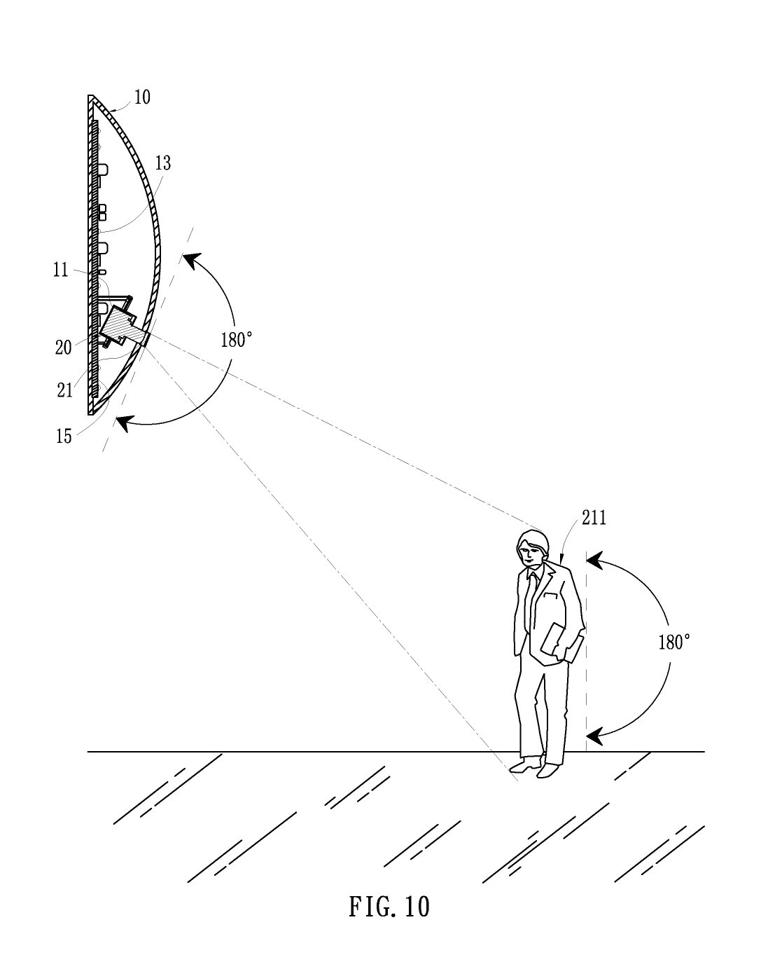

Referring to FIGS. 9 and 10, FIG. 9 shows a wall-mounted light and FIG. 10 shows the light is mounted to a wall and a phantom line is provided in front of the image capturing unit (21) of the wall-mounted light to indicate an angular range of 180 degrees. Compared to the range generally provided in a horizontal direction as shown in FIG. 8, this drawing shows an angular range generally in a vertical direction. Similarly, the vision range of the image capturing unit (21) may be varied in accordance with movement of a human being (211) in order to ensure completeness of the image (212) captured of the front side of the human being (211) is not affected as the image exceeds the vision range and is partly trimmed off. It can be seen from FIGS. 8 and 10 that the image capturing unit (21) can be arranged in a horizontal or vertical direction by being included in different forms of lights mounted in different ways so that the range of image recognition can be applied to various space arrangement and accuracy of recognition can be ensure.

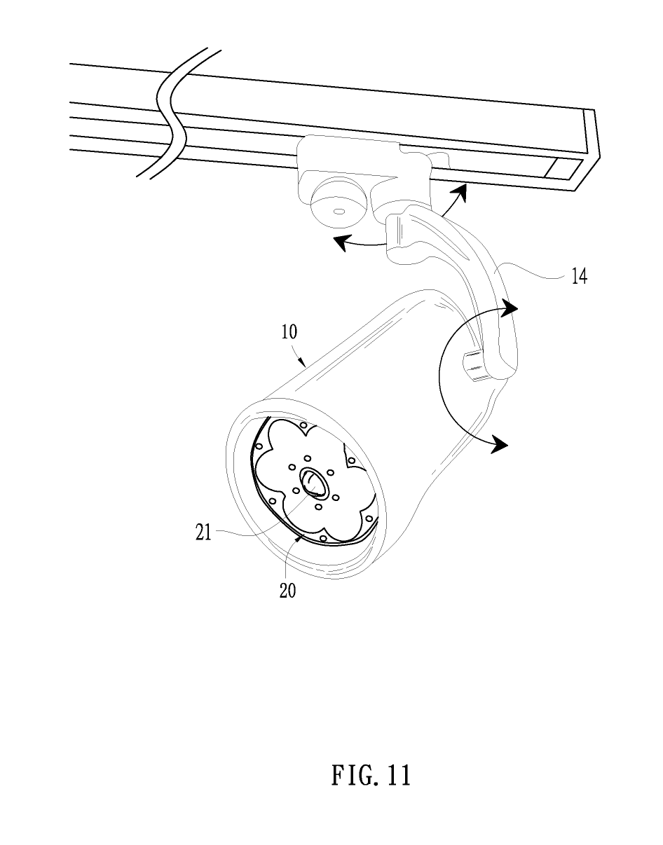

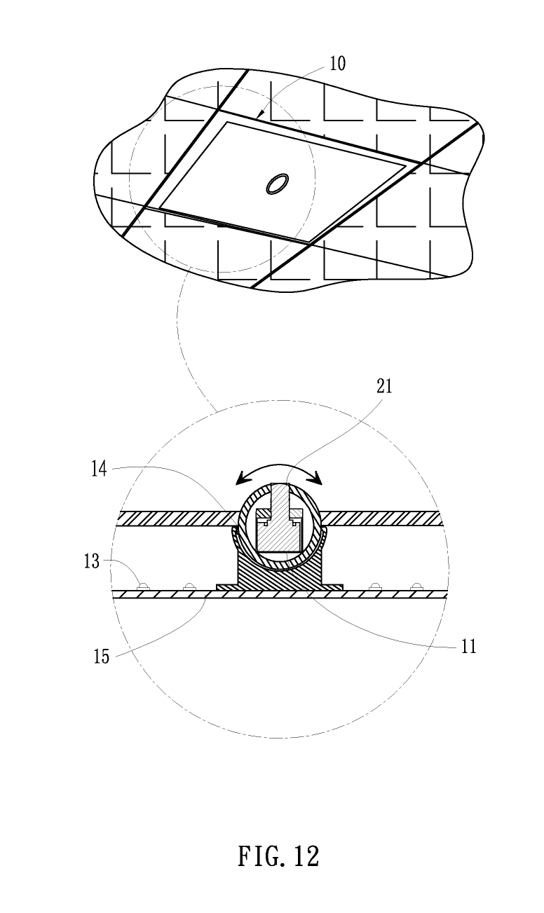

Referring to FIGS. 11 and 12, FIG. 11 shows a track light and FIG. 12 shows a light-steel-frame-supported light. The track light includes a rotatable seat (14), allowing the lighting device (10) for movement in horizontal and vertical directions, making the detection range more flexible.

In summary, the present invention provides an image-recognizing lighting device, wherein through diversity of structure among various forms of light, horizontal or vertical installation may be achieved to allow the image capturing unit (22) to capture, in a more accurate way, a front image (212) of a person or human being (211) within an angular range of 180 degrees for more accurate determination of image recognition. In addition, the master control board (10) is provided for connection with in such a way as to drive or activate lighting and video recording and for additional connection with an expansion module (30) to thereby make the applications thereof more flexible and expandable.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An image-recognizing lighting device, comprising: a lighting device, which comprises, arranged therein, a master control board, an infrared sensor, and a light-emitting diode (LED) for lighting; an image module, which is connected to the master control board and comprises: an image capturing unit that is operable for capturing at least an image of a front side of a person within and covering an angular range of 180 degrees; an image storage unit that stores the image and pre-stored data of the person; and an image recognition unit that is connected to the image storage unit to access the image, the image recognition unit being operable to conduct an analysis of the image to acquire a characteristic value, the image recognition unit being also operable to compare the characteristic value with the pre-stored data, such that when the characteristic value matches the pre-stored data, the master control board is caused to activate the LED for illumination and when the characteristic value does not match the pre-stored data, the master control board is caused to activate the LED for illumination and to also activate the image capturing unit to conduct video recording and storage.

2. The image-recognizing lighting device according to claim 1 further comprising: an expansion module, which is connected to the master control board and arranged in the lighting device, wherein the expansion module comprises: a sound effect unit for reminder and alarm and a transmission unit for transmitting the image and data.

3. The image-recognizing lighting device according to claim 1 further comprising: a rotatable seat, which is mounted on an outer side of the lighting device for adjustment of the image capturing unit in a horizontal direction for an angular range of 180 degrees and in a vertical direction for an angular range of 180 degrees.

4. The image-recognizing lighting device according to claim 1 further comprising: a rotatable seat, which is mounted on an outer side of the image capturing unit for adjustment of the image capturing unit in a horizontal direction for an angular range of 180 degrees and in a vertical direction for an angular range of 180 degrees.
